(19) United States
(12) Patent Application Publication
(10) Pub. No.: US 2008/0109356 A1
(43) Pub. Date: May 8, 2008

(54) Fraud detection system and method for loading stored value cards

(76) Inventors: David B. Sutton, Monroe, MI (US); Douglas E. Blasiman, Bowling Green, OH (US)

Correspondence Address: BROOKS KUSHMAN P.C., 1000 TOWN CENTER, TWENTY-SECOND FLOOR, SOUTHFIELD, MI, 48075, US

(21) Appl. No.: 11/543,713

(22) Filed: Oct. 4, 2006

(51) Int. Cl. G06Q 40/00

(52) U.S. Cl. 705/44

(57) ABSTRACT

A database is provided for maintaining card loading merchant information including a merchant security rating as well as a cardholder information and card activity data. A fraud detection program is run at the time of a loading event or an ATM withdrawal event in order to determine whether or not the transaction would exceed security limits which varies a function of the loading merchant security rating.

### BACKGROUND OF THE INVENTION

1. Field of the Invention

The present invention related to debit card fraud detection particularly card loading fraud.

2. Background Art

It is widely known that credit card and debit card issuing financial institutions or their issuing partners collect data for various purposes. One of the purposes of such data collection is to build a cardholders usage profile for security and fraud detection, as well as marketing purposes.

Fraud detection is more important than ever given the growing transaction activity on the internet and the potential for fraudulent card usage. Issuers spend considerable resources in developing more sophisticated fraud detection systems not only to protect consumer credit but to protect their cardholders from the growing threat of identity theft and to limit loss. The more effectively issuers manage fraud, the more profitable their portfolios and the greater degree of security and reliability they can offer their cardholders. In addition, such data is useful to the issuer for data collection and mining for marketing purposes so that they can more effectively categorize cardholder types and create affinity programs that target certain cardholder groups.

Credit card issuers have directed their fraud detection efforts to protection of card account records and their underlying credit balances from unauthorized use. With the growing popularity of stored value or prepaid debit cards, there is a growing need to create a system and business process to detect fraudulent loading of funds to such prepaid cards.

Stored value or prepaid cards are loaded periodically at authorized locations. Such loading locations have been provisioned with a technological interface that enables them to connect to the issuer or marketer of the card (the holder of the card account record) in order to add the corresponding value to the card account record desired by the cardholder. The loading location designates a funding account in advance from which funds are to be debited for the funds collected from the cardholder for the purpose of adding monetary value to their card. Since instant funds availability is highly desirable by the cardholder, there is a period of time between the time the loading location collects the funds from the cardholder until funds are debited from their funding account by the card issuer. It is important to point out that cards must be registered with the issuer prior to use, but can be loaded with value without further contact with the issuer.

### Loading Location Fraud

This creates a potential for fraudulent loading either by the owner of the loading location or their employees. For example, it could be possible that an employee of a store provisioned to load prepaid cards could fraudulently load a card and then go to an ATM to remove funds from the card. As discussed, the retailer assigns a funding account from which funds are removed daily via an ACH electronic funds transfer by the issuer/marketer for cards loaded the previous day. Therefore, the retailer's account could be debited for the amount of the load without funds coming in to support the debit. Accordingly the retailer could be in a deficit position on such a fraudulent load transaction.

The employer may need to file a complaint with the authorities. The owner can identify the employee's fraudulent loading transaction since an employee ID number is required to complete a load transaction. In addition, it is possible that the issuer can identify the employee by means of the camera at the ATM location at the time the funds were withdrawn. The employer may also maintain security camera records which they can to identity of the employee perpetrating the fraudulent load transaction.

It is also possible that the owner of the load location could engage in a fraudulent load transaction in much the same way as the employee previously described. The owner could load a card in inventory, follow the card registration procedure using fraudulent information, and then go to an ATM and withdraw cash. Then, when the issuer attempted to debit the owner's designated funding account there were no funds available, the issuer would be at risk of a loss and possibly need to pursue collection efforts which may include filing a civil action and or lodging a criminal complaint.

### Loading Funds Fraud

Another way a load fraud could occur would be for a customer to load a prepaid card using an unauthorized source. They could load value to their card by using a fraudulent or stolen credit card or check to pay for the monetary value of a load. So, once a card is loaded with funds paid for with the stolen credit card or check, the prepaid cardholder would have a means to remove value from the prepaid card at an ATM location. To reduce the opportunity for such consumer fraud, the loading location could require that such loads to prepaid cards be paid for with cash rather than a credit card or a check.

These types of fraudulent card loading activity revolve around a series of steps to convert one monetary value on a stolen or fraudulent credit card, debit card or check to cash which can be used easily. Though fraud is a very real threat that cannot be completely eliminated, a system to help to detect and manage loading fraud would be highly desirable.

### SUMMARY OF THE INVENTION

Accordingly the fraud detection system and method of the present invention is directed to the creation of a stored value card loading fraud detection tool designed to detect and manage fraud in connection with the loading of funds on stored value cards.

This fraud detection system sets certain parameters established for the loading location and cards and then collects usage information to establish an ongoing rating system for card sales and loading locations as a means to detect and predict card loading fraud originating from a certain load locations. In one embodiment of the invention loading merchant activities are limited based upon expected loading volume for that loading site. In another embodiment of the invention ATM withdrawal activity in monitored and restricted based on the security rating of the loading location.

### BRIEF DESCRIPTION OF THE DRAWINGS

FIG. 1 is a schematic illustration of the debit card processing system;

FIG. 2 illustrates the generation of the merchant record database;

FIG. 3 illustrates a representative cardholder record in the cardholder database; and

FIG. 4 illustrates a schematic diagram of the implementation of the fraud detection system.

### DETAILED DESCRIPTION OF THE PREFERRED EMBODIMENT(S)

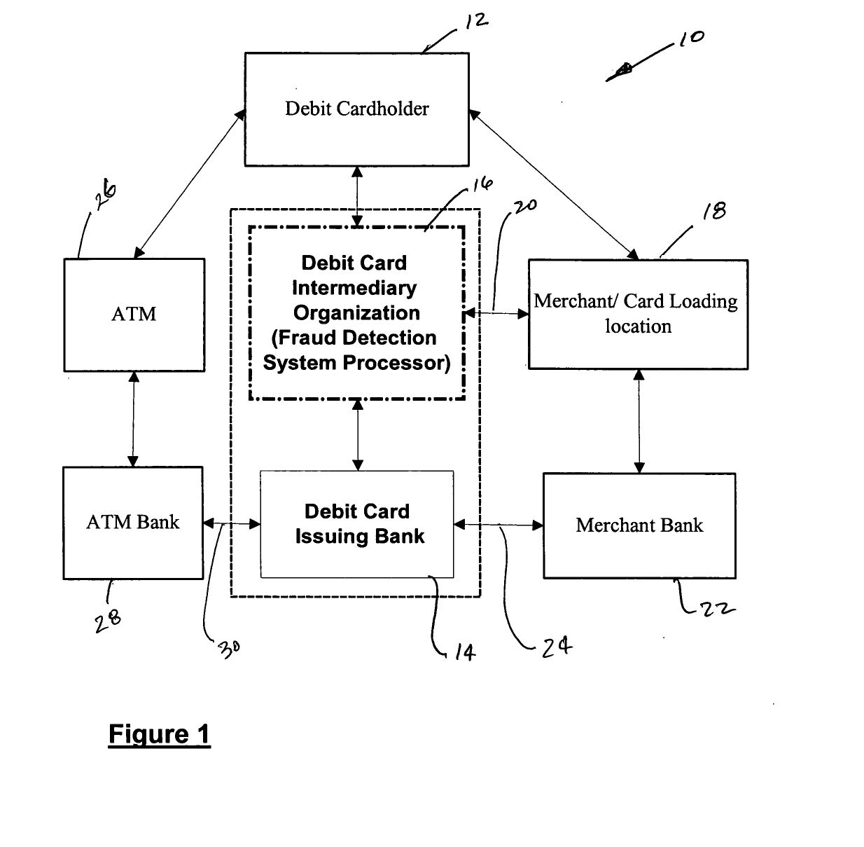

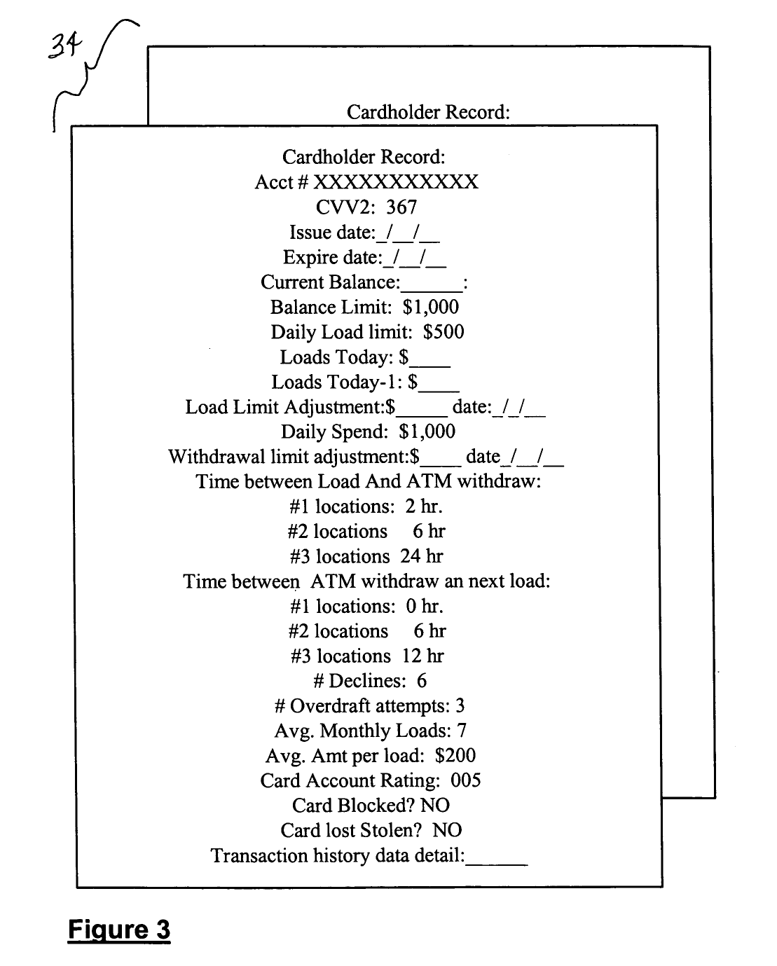

A representative example of a system employing the present invention is illustrated in FIGS. 1-4. FIG. 1 illustrates a debit card processing network 10 made up of a debit card holder 12 which has a debit card which is either issued directly by a card issuing bank 14 or issued by a debit card intermediary 16 which is affiliated with the bank, but, administers the debit card program. It should be appreciated that there may be thousands of credit cards issued and administered by the debit card intermediary organization 16 or directly by the bank 14. The debit card holders will physically purchase their debit cards either directly from the issuing bank or debit card intermediary or through a network of retail merchants who can sell debit cards and provide card loading and reloading services. A single loading merchant 18 is shown in FIG. 1, but it should be appreciated that there may be multiple thousands of loading merchants which are affiliated with the debit card intermediary 16. Card loading merchants 18 communicate electronically with the debit card intermediary 16 via an Automated Process Interface (API) 20 to facilitate the loading of funds on debit cards in the system.

The debit card holder 12 can use his or her debit card to make purchases at thousands of retail outlets accepting credit cards which are processed through a standard credit card exchange. For example, credit cards could be associated with a national credit card company such as Master Card, Visa or American Express. Purchases made at a merchant accepting debit cards will be processed back through the merchant bank 22 through credit card clearing exchange 24. The debit card holder can also utilize the debit card at ATM's 26 in order to obtain cash. ATM 26 is associated with an ATM bank 28 and the financial transaction is cleared through an ATM network 30 in which the debit card issuing bank 14 is a participant.

The present invention is a computer implemented fraud detection system which is either run at the debit card intermediary organization 16 or directly at the debit card issuing bank 14. No intermediary organization is utilized. The fraud detection system monitors merchant card loading activity and preferably also monitors ATM activity in order to detect transactions which are suspected as being fraudulent and to automatically limit card functionality.

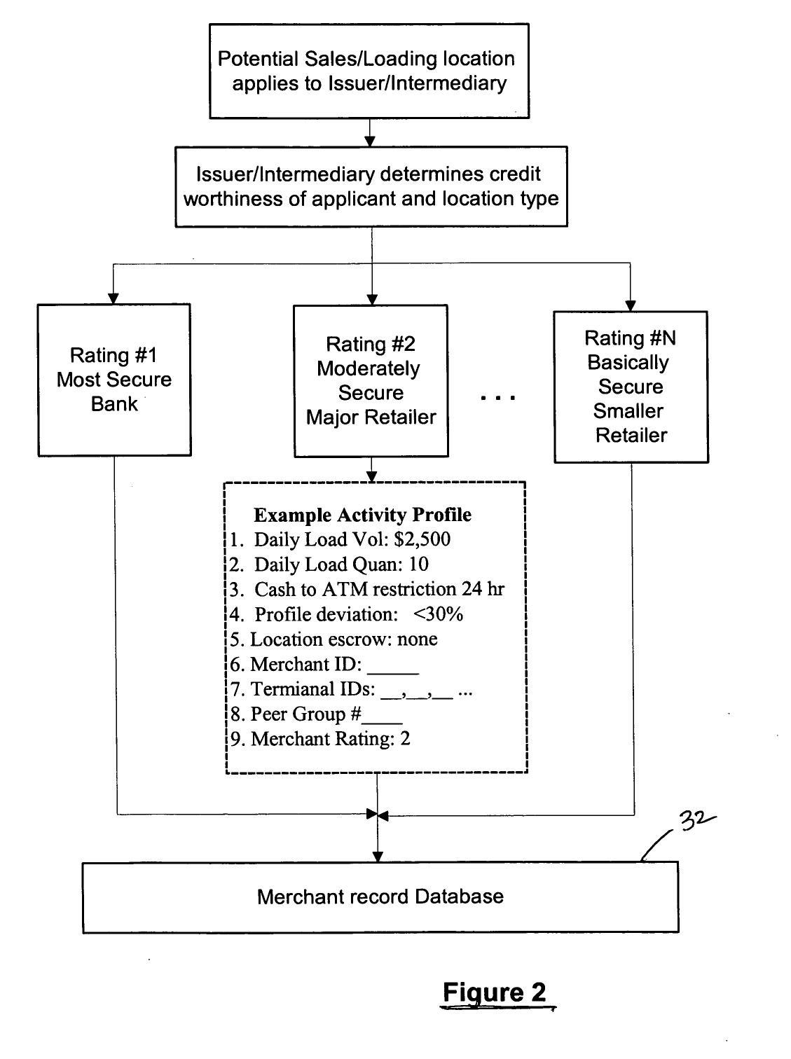

Debit card issuing bank 14 or debit card intermediary organization 16 will establish a network of card loading merchants 18. As illustrated in FIG. 2, the issuing bank or intermediary organization will determine the credit worthiness of each merchant which will act as a sales and/or loading location for debit cards. Preferably, merchants will be ranked in a number of categories based upon the level of security employed by the merchant and the merchant's credit risk. As illustrated in FIG. 2, a #1 rating may be given to banks which sell and load credit cards. Banks have a very high credit rating and bank transactions which are conducted by a teller are inherently secure due to the employee selection, training and cash management policies of typical banks. A #2 rating may be given to a major retailer such as a drugstore chain which would sell the lowest load debit cards. This type of merchant would typically be less secure and more susceptible to employee related fraud while merchant credit risk may remain minimal. A third rating may be given to smaller retailers which may have greater employee risk and more or less poorer credit quality. It should be appreciated that this invention could be utilized with two or more ratings and could even be utilized in a system where each merchant had a unique custom security rating.

An example merchant profile is illustrated in FIG. 2. The profile would have a daily load limit for the merchant in gross dollars as well as a load limit in transaction quantity. In the example profile, the merchant has a daily dollar load limit of $2,500.00 and a 10 load limit. These load limits can be set by the issuer/ intermediary initially, based upon expected volumes and can be modified in the future based upon actual data. Preferably, the profile will also have a cash ATM restriction limit, a profile deviation limit and an indication of whether or not a merchant escrow is required. The profile will include the merchant ID for API transactions as well as the terminal of ID's of all of the processing terminals associated with the merchant location. Preferably, the merchant will be grouped in a peer group established by the issuer/intermediary and the merchant will be assigned one of a plurality of security ratings. The data of all of the merchants are combined into a merchant database 32.

A cardholder database is also created and maintained on a computer system operated by the issuer/intermediary. Each cardholder will have a cardholder record which will have, in addition to the traditional account number, a security code, issue date, expiration date, current balance and balance limit. It will have a series of data fields designed to track card loading activity and preferably, ATM activity. Security ratings will be established for various types of transactions based upon the loading location, security level, to set load limits and withdrawal limits for the specific card in question. Preferably, the cardholder of record will also include specific transaction history and data details. All of the cardholder records collectively form a cardholder database 34.

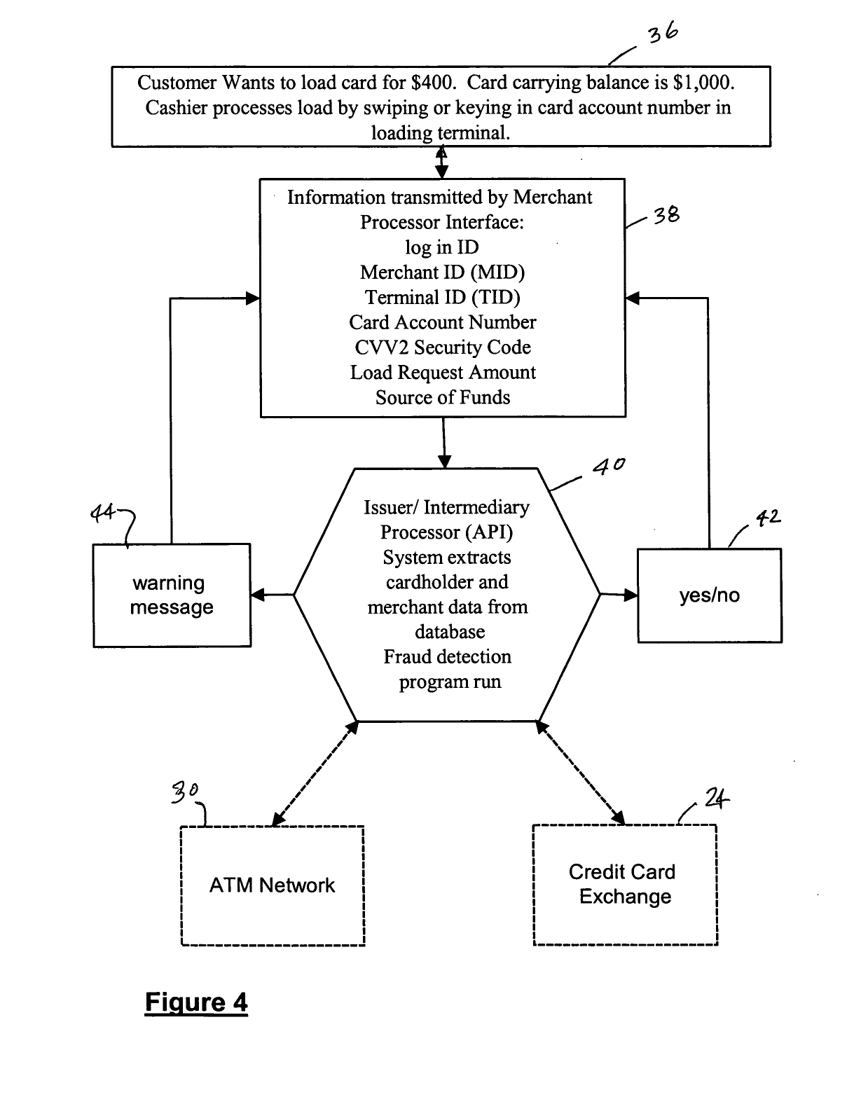

The operation of the system is illustrated with reference to FIG. 4 when a customer presents a card to a loading merchant to load funds, the merchant will accept the card and the cash to be loaded and swipe the card or key in the card number at the loading terminal. This illustrated in block 36 in FIG. 4. Information will be automatically transferred from the loading merchant terminal to debit card intermediary 16 or issuing bank 14. The API network 20 is illustrated by block 38 in FIG. 4. The terminal will transmit log in information, merchant ID and terminal ID along with a card account number, security code, load request amount and optionally the source of funds. This information will be processed in fraud detection program at block 40 which is implemented on a computer associated with the issuing bank or debit card intermediary. The system extracts the cardholder information from the cardholder database 34 and then merchant records from merchant database 32 runs a series of fraud detection routine in order to determine whether to decline or accept the loading transaction and updating the merchant and cardholder records. If the security tests are passed, an accept message is transmitted at block 42 back to the loading merchant via the API network, at which time the loading transaction is completed at the merchant loading location, a receipt provided to the cardholder and the cardholder's account credited the amount of the load less any load fees. If the fraud detection system detects suspected fraud, a “No” message is transmitted back to the loading merchant and the loading transaction is not consummated. It is preferable that borderline cases which are acceptable, also generate a warning message which is transmitted back to the loading merchant as illustrated in block 44. The fraud detection system also receives information from ATM network 30 and credit card charge exchange 24 in order to update and debit the card balance in the event of cash withdrawals in an ATM or a purchase at a merchant accepting debit cards.

In order to detect cardholder load fraud, preferably the fraud detection program will limit the total amount of load transactions which may take place during a given time interval for a given merchant or even a given terminal ID. When the daily load limit is exceeded, the loading merchant will no longer be allowed to load funds on debit cards. As previously indicated, any warning message may be provided as the load limit is neared. Provisions may be provided to allow a merchant to contact the debit card intermediary to temporarily raise the load limit providing certain security verification. This provides an uninterrupted use of the loading station yet provides heightened employee load fraud security.

A common type of load fraud occurs when a dishonest employee sells and loads debit cards or simply reloads a number of pre-issued debit cards without actually receiving the funds from a card holder. These cards can be used to buy goods at merchants accepting credit cards. Alternatively these fraudulently loaded cards can be taken to an ATM and the available cash balance withdrawn. In order to limit this type of fraud the cash withdraw from an ATM closely following at a loading evident or the reloading of a card closely following its initial loading and withdraw of funds at an ATM may be limited. Since ATM loading fraud is unlikely to occur at a bank or other highly secure rated loading merchant a time delay between a load at an ATM withdrawal or an ATM withdrawal in the next load will be very short or not existent for the most securely rated loading merchants as opposed to unsecured merchants. For example, the time between a load and an ATM withdrawal may be 0 to 2 hours for loads made at banks while up to 24 hours for loads made at loading merchants having a rating of 3. Similarly, the reload limit after an ATM withdrawal may vary as a function of reloading a location's security level.

Not all ATM withdrawals will be for the entire card balance, therefore, the load limit and the withdrawal limit may be downwardly adjusted pro rata based upon the pre-load card balance. For example, a card has a $200.00 balance is reloaded to the balance limit there would be no prohibition for ATM withdrawals for amounts less than the pre-existing pre-load account balance.

It should be appreciated that those of ordinary skill in the art can readily develop on various variations of this fraud detection scheme such as limiting cumulative loads over a several day period or setting load limits for card holders as well as merchants based upon a rolling 12 hour period in order to prevent the fraudulent loading activities to be shifted to a time immediately following the resetting of the loading limit.

It is further envisioned that the load limits for merchants, as well as the loading limits for cardholders, may be varied automatically based upon the time of the year and historical data. For example, if merchants routinely experience high loading activity on paydays or following preceding holidays, the load limits for the merchant can be automatically adjusted based upon historic data. Further, if similar merchants having a widely graphically dispersed location are grouped as a peer group the activity of the entire group can be monitored so that the balance limit for merchants can be automatically adjusted as loading activity increases peer wide during high periods of everyone's balance limit would be increased proportionally and during low activity periods balance limits decrease. This will serve to tightly limit loading fraud in any particular merchant while hopefully avoiding declining loading event where there is no fraud present.

When cards are loaded there are various security checks that are implemented. For example, when a request comes from a terminal provisioned to load prepaid cards, the request is routed through a processing interface that be routed at various points and ultimately arrives at the card account database record maintained by the issuing processor for the card to be loaded. It first looks to where the load in originated and confirms that it came from an authorized source, loading location and terminal identification. Next, it looks to certain restrictions on the program that governed the card account established by the card issuer. So for example, if the card program required that the card could be loaded with a limit of $500 at any one session and a maximum balance on the card of $1,000, a terminal request that had been validated for $1,000 would return a “decline” message after first verifying the card account and expiration date. It would also return the same message if the card had been lost, cancelled or blocked on the card account record. The card could also be restricted from being used at an ATM within “x” hours of loading funds which could act as a deterrent for potentially fraudulent transactions. The system also provides for real time monitoring of the automated process interface (API) for loading activity by the number of transactions per hour or other unit of measurement and the amount of such loading activities.

The system also provides exception reporting for evaluation by the security department of the issuer. An example would be a load that was requested for a card where the balance on the card exceeded the carrying balance established for the card account. The account could be reviewed either by the security department or through an automated process that may elect to take corrective action such as blocking the card or closing the account. It this were to occur, the funds on the card would be held pending resolution. To reactivate the funds the cardholder would be required to call the card issue customer service and supply a password or other information that would enable the system to make a decision.

At the time a location is approved for card sales and loading they would also be assigned a rating that corresponds to those established though the collection of data as described above through their peer group. So for example, a “1” could designate a high security sales and loading location like a bank and other ratings such as a “2” or “3” would imply a location where there is greater loading fraud risk. This rating is the product of a mathematical formula utilizing the data that is being regularly collected from all peer locations and has the ability to fluctuate with the sales season.

For example, if a store loading location were a “2” designation, this may correspond to a convenience store in the Midwest. At that time certain perimeters are assigned to the location that reflects the loading characteristics of that peer group. So for example, stores in the Midwest are limited to “x” loads per hour during the month of May. But in the month of December during the busy holiday season the number of loads per hour would grow to reflect the seasonal activity of all the peer stores in the Midwest. The purpose of this system would be to isolate or reject behavior that does not conform to the level established by the peer group and thus identify extraordinary behaviors. Of course, if the sales location submitted a legitimate request, the loading location could call the card issuer at the help desk and provide additional information to request an over-ride of the system for that one transaction. In addition, the system could be expanded to “learn” the characteristics of the cards being loaded. So, if according to the peer group the time period from loading the card to using it at an ATM was 24 hours, any card that was used at an ATM in less than 24 hours would be declined. The premise of the system conforms users to limits established by the peer group to reduce fraud by identifying extraordinary activity.

For example, a bank loading location would be assigned a #1 designation. The assumption is that bank sales locations with high security have controls in place to manage card loading activity and to ensure compliance. Major retail locations also have a greater security and compliance procedures in place. Smaller locations may provide less security and compliance and may therefore be more prone to fraudulent load activities and receive the highest risk designation. Initially, the sales location is assigned a rating with certain corresponding parameters in place. For example a sales location which has been assigned #2 designation which means a daily load limit of “X” loads established by the activity of the peer group. If the location were to attempt to exceed that number either on the amount or number of loads, the issuer's security department could call the sales location to investigate. This kind of contact by the issuer's security monitoring department would act as a potential deterrent to the loading location and their employees. If the designated security department of the sales location confirmed these were legitimate sales or loads they would be cleared of further investigation of this occurrence. If they were unable to confirm they were legitimate sales or loads, the issuer could temporarily deactivate their ability to load funds on card. This deactivation would occur within minutes of the decision to do so. Since all card loading activity is instantaneous, it is imperative that the issuer have and maintain real time access to all locations and all loading activity and have the ability to deactivate the technological interface used to load cards with value, in real time.

The sales and loading location conforms to the peer group in card sales and their own sales and loading pattern. This enables the issuer's fraud detection algorithm to reflect the actual behavior of the peer sales and loading location. Once established, the rating “floats” based on a mathematical formula that incorporates certain variables. In addition, this fraud tool provides a “floating cushion that alerts the issuer's security and fraud detection department of a sales and reloading location reaching or exceeding a certain threshold of potentially fraudulent cardholder activity. This system provides not only a real deterrent; e.g. sales locations are advised if they fall outside of parameters, their account and ability to load funds to cards could be suspended. In addition, sales locations and their employees learn that the issuer's automated fraud detection system is constantly monitoring sales and loading activity which acts as a deterrent for fear of discovery. In addition, smaller locations that generate more decline requests than those established by the peer group may be required to maintain on deposit funds to support their daily loads. So, if the peer group establishes $1,000 as the daily load level, this location may be required to place $1,000 into an account as a deposit. Once again, this would act as a fraud deterrent since the owner would be notified of the deposit requirement and then would investigate internally as to the person who was attempting to process load transactions that were being rejected.

The system also profiles the stored value card at the time of reload based on historical activity on the card. The card issuer maintains and has access to purchase and loading activity of the cardholder and can build a profile based on actual card usage. So for example, if the card had ever been loaded and funds had been withdrawn from an ATM within “X” hours, the load to the card could be declined through a “decline” message to the loading terminal. The system collects and builds a cardholder loading profile and can identify certain loading behavior that falls outside of the perimeters that exceed those established by the cardholder's normal activity. In addition, if the card were blocked, or being investigated for suspicious activity, or if the card had ever been loaded previously with a credit card that had been subsequently reported lost or stolen, the load would fail by returning a “decline” message to the loading terminal.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A method of deterring fraudulent loading of a debit card comprising:
providing a debit card system for distributing, activating and managing debit cards which can be used with an existing ATM network to enable the card holder to withdraw cash;
maintaining a loading merchant database of debit card loading merchants which includes a security rating;
monitoring and storing in a card holder database card loading activity for each of the debit cards including information related to the time of the load and loading merchant;
monitoring and storing in the card holder database information related to recent ATM withdrawal activities for each of the debit cards; and
limiting debit card functionality based upon recent ATM withdrawal activities loading activities and loading merchant security rating in order to reduce financial exposure to loading fraud.

2. The method of claim 1, wherein the step of limiting debit card activity further comprises limiting the minimum time between an ATM withdrawal and the loading of a debit card based upon the loading merchant security data where the time delay is greater for low security merchants than merchants having a high security rating.

3. The method of claim 1, wherein the step of limiting debit card activity further comprises limiting the time between the loading of a debit card and the subsequent withdrawal of a predetermined percentage of the available balance at an ATM based upon the loading merchant security data wherein the ATM withdrawal delay period will be greater for merchants having a low security rating than loading merchants having a high security rating.

4. The method of claim 1, wherein the step of limiting debit card activity further comprises limiting the time between the loading of a debit card, the withdrawal of a predetermined percentage of the available balance at an ATM and the re-loading of the debit card based upon the loading merchant security data wherein the ATM withdrawal delay period will be greater for merchants having a low security rating than loading merchants having a high security rating.

5. A method of deterring fraudulent loading of a debit card comprising:
providing a debit card system for distributing, activating and managing debit cards which can be used with an existing ATM network to enable the card holder to withdraw cash;
maintaining a loading merchant database of debit card loading merchants which includes a security rating, recent loading activity and an expected load volume for each loading merchant; and
limiting debit card loading abilities a loading merchant based upon recent loading activities, loading merchant security rating and expected loading merchant load volume in order to reduce loading fraud.

6. The method of claim 5 further comprising:
transmitting information related to an attempt to load funds on a debit card from the loading merchant to an entity maintaining the loading merchant database over an automated process interface;
evaluating the merchant's security rating, recent loading activity and an expected load volume to determine if the attempted transaction falls within loading limits; and
automatically transmitting a message to the loading merchant over the automated process interface to authorize or decline the attempted load transaction.

7. The method of claim 6 further comprising:
automatically adjusting the expected load volume of a loading merchant at a given time based upon historic loading activity volume increases caused by holidays and pay days.

8. The method of claim 6 further comprising:
automatically adjusting the expected load volume of a loading merchant at a given time based upon loading activity volume of a group of loading merchants in a common peer group.

9. A system for deterring fraudulent loading of a debit card which is used in conjunction with a network of card loading merchants as well as an existing ATM network to enable a cardholder to withdraw cash, the system comprising:
an electronic database maintained by an entity affiliated with a debit card issuing bank affiliated which participates in a credit card clearing exchange as well as an ATM banking network;
a fraud detection program executed on a computer system interfacing with the electronic database loading merchants and cardholders;
communicating with the loading merchants through an automated processing interface in order to authorize loading transactions; and
further communicating with an ATM banking network via the debit card issuing bank wherein the fraud detection program limits debit card functionality based at least in part on a security rating assigned to the loading merchant.

10. The system of claim 9 wherein the fraud detection program provides a load or no load output to the loading merchant seeking authorization to load money on a debit card based in part upon the merchant's recent card loading activity relative to an expected volume.

11. The system of claim 9 wherein the fraud detection program provides a load or no load output to the loading merchant seeking authorization to load money on a debit card based at least in part upon recent ATM cash withdrawal activity of the card holder and the security rating of the loading merchant.

12. The system of claim 9 wherein the fraud detection program will limit debit card ATM withdrawals based upon the time between the card loading, the attempted ATM withdrawal and the security rating of the loading merchant.
